(19) United States
(12) Patent Application Publication
(10) Pub. No.: US 2004/0117836 A1
(43) Pub. Date: Jun. 17, 2004

(54) Method and system for network storage in a media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,439

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/469,182, filed on May 9, 2003.
(60) Provisional application No. 60/444,243, filed on Jan. 30, 2003.
(60) Provisional application No. 60/464,697, filed on Apr. 23, 2003.

(51) Int. Cl. H04N 7/173; H04N 7/00; H04N 7/16; H04N 7/18; H04N 11/00

(52) U.S. Cl. 725/81; 725/80; 725/86; 725/135; 725/133; 348/552

(57) ABSTRACT

Certain embodiments of the invention may be found in a method and system for providing media in a communication network. In this regard, certain aspects of the method for providing media in a communication network may comprise receiving a media file at a first home via the communication network. The media file may be received from outside the first home and a first format for the received media file may be determined within the first home. Accordingly, the received media file may be converted from the first format to a second format that is compatible with presenting and/or playing the converted media file on a television screen within the first home.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/457,179 (Attorney Docket No. 14825US01 01015P-BP-2831) filed Mar. 25, 2003;

U.S. Provisional Application Serial No. 60/469,182 (Attorney Docket No. 14989US01 01054P-BP-2814) filed May 9, 2003;

U.S. Provisional Application Serial No. 60/444,243 (Attorney Docket No. 14282US01) filed Jan. 30, 2003; and

U.S. Provisional Application Serial No. 60/464,697 (Attorney Docket No. 14822US01) filed Apr. 23, 2003.

This application also makes reference to:

U.S. application Ser. No. ______ (Attorney Docket No. 14185US02 01001P-BP-2800) filed Sep. 8, 2003; and

U.S. application Ser. No. ______ (Attorney Docket No. 14274US02 01002P-BP-2801) filed Sep. 11, 2003; and

All of the above stated applications are incorporated herein by reference in their entirety.

### FIELD OF THE INVENTION

Certain embodiments of the invention relate to information storage. More specifically, certain embodiments of the invention relate to a method and system for media independent storage access and distribution of data in a media exchange network.

### BACKGROUND OF THE INVENTION

A personal computer (PC) is often utilized to send email messages and attached files over the Internet to other personal computers. The attached files may include many types of digital format files for example, text files, PDF files, MP3 files, JPEG files, MPEG files, and TIFF files. Various personal computer network configurations such as a local area network (LAN) or a wide area network (WAN) may be used to transfer or migrate media and data from one personal computer to another.

Typically, media and data are transferred from a first personal computer to a server or through multiple servers to a second personal computer or to multiple personal computers. Also, in various personal computer network configurations, media and data may be migrated directly between one personal computer and another, between a personal computer and a server, or between a server and archival storage, for example. As a result, a user has the capability to distribute media and data in a PC-based environment.

A personal computer is often utilized to access media stored on a media peripheral via a wired link. The accessing of media stored on such media peripherals involves the: (1) exchange of media meta information, for example, media file names, sizes, dates, resolution and format; (2) uploading of media to the media peripheral; or (3) downloading of media from the media peripheral. As a result, a user is able to extract media for printing, routing, or processing or load media for playback or review. Even so, the overall process for doing so is a manual process that may require significant user interaction and may be time consuming.

For example, in the case of using a personal digital assistant (PDA), a user may currently have a calendar of appointments stored on the PDA. In order to download the calendar to a PC, the user: (1) removes the PDA from its case; (2) attaches a cable between the PC and the PDA; (3) powers up the PDA; (4) places the PDA in a download mode; (5) runs a personal computer application that copies the calendar file from the PDA to the PC via the cable; (6) powers down the PDA; (7) removes the cable; (8) places the PDA into its case; (9) and exits the personal computer application. This is a very tedious and time consuming process, and, especially when problems arise, requires a fairly savvy technically inclined user.

Also, media and data may be uploaded from a personal computer to a media peripheral in a similar manner. For example, a user may download an operating system update for his personal digital assistant from the Internet to his personal computer. The user may then follow a process, similar to the reverse of the process described above, to download the operating system update to the personal digital assistant.

Another drawback is that conventional systems may require the use of multiple systems and/or software to handle different media types. For example, a set-top box may be used to access MPEG data but a personal computer may have to be used to access TIFF or PDF formatted data. Consequently, a user watching content from a set-top box on a television monitor, for example, may have to send a received TIFF or PDF file to a personal computer for viewing.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain aspects of the invention may be found in a method and system for providing media in a communication network. Certain aspects of the method for providing media in a communication network may comprise receiving a media file at a first home via the communication network. The media file may be received from outside the first home and a first format for the received media file may be determined within the first home. Accordingly, the received media file may be converted from the first format to a second format that is compatible with presenting and/or playing the converted media file on a television screen within the first home. The received media file may be audio, video, images, graphical and/or textual media.

The received media file may be decoded and/or decrypted within the first home or it may be transcoded from the first format to the second format that is compatible for presentation or display on the television screen within the first home. The converted media file may be directly transferred to one or more media peripherals that may be located within the first home. The converted media file may also be distributed or migrated to a media peripheral within the first home and/or a media peripheral within a second home via a wired and/or wireless connection. In this regard, authorization may be received prior to distributing or migrating the converted media file to a media peripheral that is located at the second home or outside the second home.

In another aspect of the invention, the converted media file may be stored in a network attached storage and/or storage area network located within a first home and/or a second home. The stored converted media file may be retrieved and displayed on the television screen that is located within the first home. The received media file may also be stored in at least one of a network attached storage, a storage server and a storage area network prior to being converted from the first format to the second format.

Another embodiment of the invention may provide a machine-readable storage, having stored thereon, a computer program having at least one code section for providing media in a communication network. The at least one code section may be executable by a machine, thereby causing the machine to perform the steps as described above for providing media in a communication network.

Certain embodiments of the system for providing media in a communication network may comprise at least one processor that receives a media file at a first home via the communication network. The media file may be received from outside the first home. The processor may determine a first format of the received media file within the first home and convert the received media file from the first format to a second format. The second format may be compatible with presenting and/or playing the converted media file on a television screen within the first home. The received media file may be audio, video, image, graphical and/or textual media. The processor may be a media processing system processor, a media management system processor, a computer processor, a media exchange software processor and/or a media peripheral processor.

Notwithstanding, the processor may decode or decrypt the received media file within the first home or it may transcode the received media file from the first format to the second format that is compatible for presentation on the television screen within the first home. The converted media file may be transferred by the processor to one or more media peripherals that are located within the first home. The processor may also be configured to distribute the converted media file to a media peripheral within the first home and/or a media peripheral within a second home via a wired and/or wireless connection. In this regard, the processor may be adapted to receive authorization prior to distributing or otherwise migrating the converted media file to a media peripheral that is located at the second home or outside of the first home.

In another aspect of the invention, the converted media file may be stored by the processor in a network attached storage and/or a storage area network located within a first home and/or a second home. In cases where the converted media file is stored, the stored converted media file may be retrieved by the processor and displayed on the television screen that is located within the first home. The received media may also be stored by the processor in a network attached storage, a storage server and/or a storage area network prior to being converted from its first format to the second format.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of a system for storing, accessing and distributing data in a media exchange network or communication network in accordance with an embodiment of the invention.

FIG. 1b is a high level block diagram of an exemplary media exchange network having a media exchange server as illustrated in FIG. 1a in accordance with an embodiment of the invention.

FIG. 1c is a block diagram of the exemplary media processing system of FIG. 1a in accordance with an embodiment of the invention.

FIG. 1d is a block diagram of the exemplary media network storage device of FIG. 1a in accordance with an embodiment of the invention.

FIG. 1e is a block diagram of the exemplary media storage area network of FIG. 1a in accordance with an embodiment of the invention.

FIG. 2 is a block diagram of an exemplary media independent storage, access and distribution network in accordance with an embodiment of the invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

A method and system for media independent storage, access and distribution of data may be provided. Aspects of the invention may also include a system for interacting with data regardless of its source or origin, its format and in certain instances, its content. Aspects of the invention may include the migration or transfer of information from, for example, one or more of a plurality of personal media peripherals to one or more of a plurality of media processing system. The transfer may occur via one or more of a plurality of wired, wireless or a hybrid wired/wireless media. The migrated information may be stored and/or displayed on audio and/or video devices coupled to the media processing system. Migration and display of data may occur independent of the data source, data type and data content.

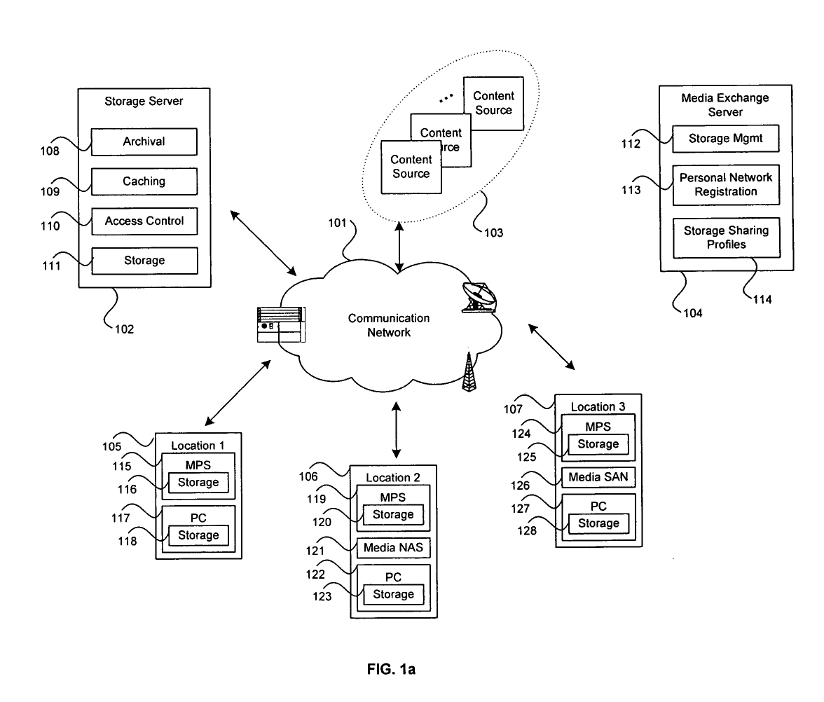

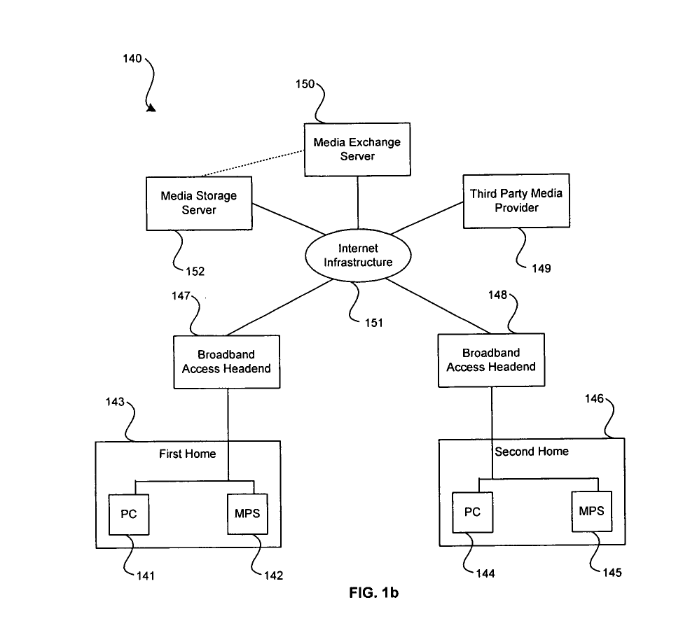

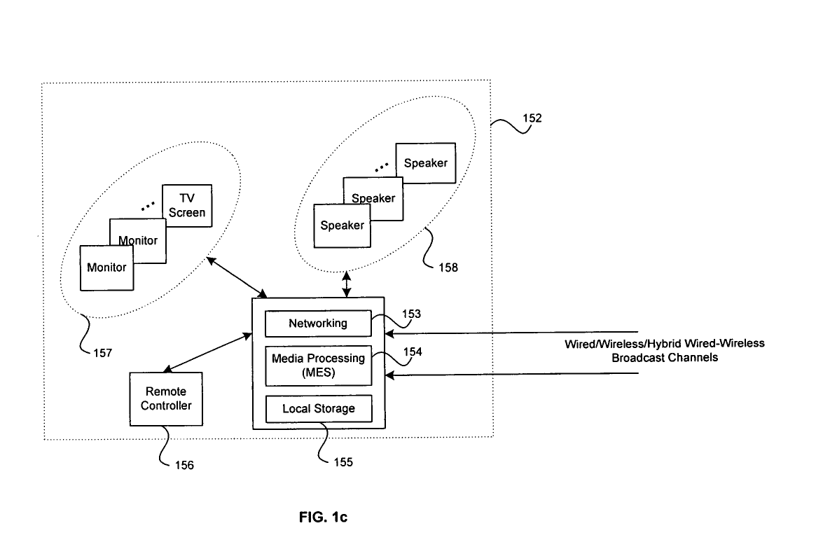

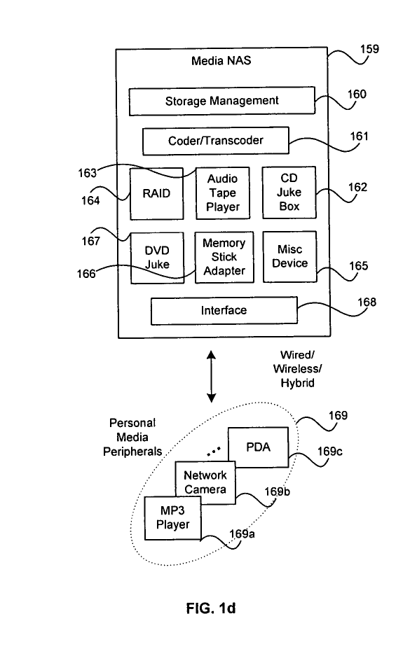

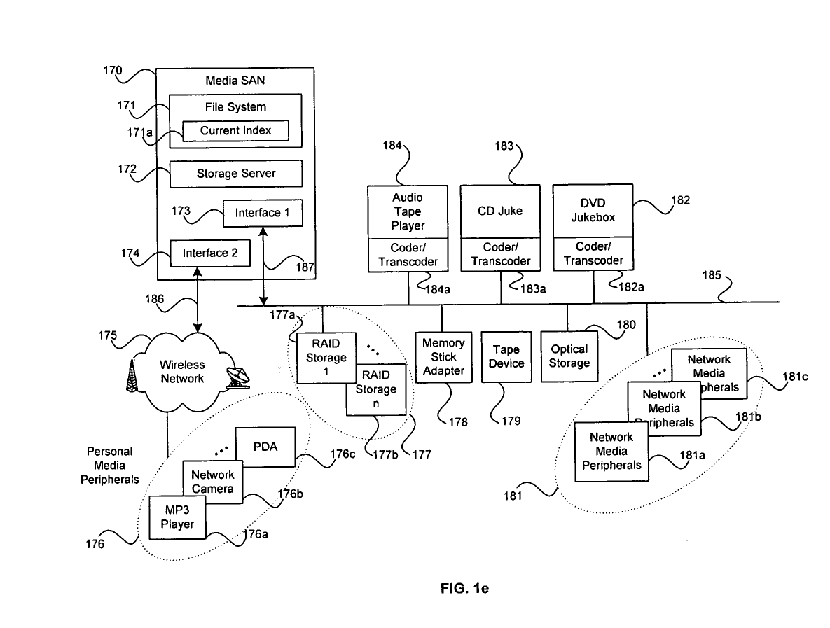

FIG. 1a is a block diagram of a system for storing, accessing and distributing data in a media exchange network or communication network in accordance with an embodiment of the invention. Referring to FIG. 1a, there is shown a communication network 101, a storage server 102, a content sources block 103, a media exchange server 104, a first location 105, a second location 106 and a third location 107. The first location 105 may be a first home, the second location 106 may be a second home location and the third location may be a third home. Any one or more of the first, second and/or third locations may be an office or business location. A media exchange network may be a

The communication network 101 may include any one or more of a intranet, the Internet, a cable network, the public switch telephone network (PSTN), a virtual private network (VPN), a satellite communication network or any wired, wireless and/or hybrid network. In this regard, the communication network 101 may include any type of network infrastructure, regardless of the access methodology or transport technology. Consequently, the communication network 101 may without limitation, utilize, for example, digital subscriber line (DSL) over coaxial cable, DSL over copper such as twister pair (TP) or unshielded twisted pair (UTP) such as category 5 (CAT 5).

The media storage server or storage server 102 may include an archival block 108, a caching block 109, an access block 110 and a storage block 111. The archival storage block 108 may be utilized to temporarily archive or permanently archive data. The caching block 109 may include a cache that may be adapted to temporarily store information in order to facilitate reduced data access time and retrieval times. The reduced data access and retrieval times may result in increased data transfer rates and higher throughputs. The access control block 110 may be adapted to control the transfer of information between the storage server 102 and any one or more of the content sources in the content resource block 103, media exchange server 104, the first location 105, the second location 106 and the third location 107 via communication network 101. The storage block 111 may provide the actual storage devices and/or interfaces and/or circuitry that may be adapted to store information which may be transferred via the communication network 101.

The media storage server 102 may be configured to interact with the media exchange server 104 and may provide temporary and/or archival storage for digital media on the media exchange network. For example, the media storage server 102 may temporarily store media files that may be addressed to certain media processing systems and/or personal computers coupled to the media exchange network. These may include media processing systems 115, 119, 124 and personal computers 117, 122, 127 of the first, second and third locations respectively,

The content resources block 103 may include at least one content source. In an embodiment of the invention, the content resources block 103 may include a plurality of content sources. These content sources may include, but are not limited to, a web portal, merchants, media providers and other data providers. The content resources block 103 may be adapted to provide data to one or more of the first location 105, second location 106 and third location 107. The media exchange server 104 may be adapted to facilitate, control and/or coordinate the transfer of information between the content sources in the content resources block 103 and the first location 105, second location 106 and third location 107. However, some transferring may occur independent of the media exchange server 104. For example, data may be transferred from the first location to the storage server 102 without interaction from the media exchange server 104. In certain instances the media exchange server 104 may be informed of the transfer after it has occurred.

The media exchange server 104 may include a storage management block 112, a personal network registration block 113 and a storage sharing profiles block 114. The media exchange server 104 may also provide various services for the media exchange network including device Internet Protocol (IP) address registration, device identification (ID) registration, channel/program setup and management, serving as a proxy for anonymity, digital rights management, media caching/storage, and billing/tracking.

The storage management block 112 may include suitable hardware and/or software that may be adapted to manage and provide the services offered by the media exchange server 104. The personal network registration block 113 may also include suitable hardware and/or software that may be configured to provision subscriber service, provide secure data transfer and authenticate subscribers for example. U.S. Provisional Application Serial No. 60/464,697 (Attorney Docket No. 14822US01) filed Apr. 23, 2003, provides an method and system for secure linking with authentication in a media exchange network, and is incorporated herein by reference in its entirety.

The storage sharing profiles block 114 may include suitable hardware and/or memory that may be adapted to store and share subscriber profiles and preferences. The sharing profiles block 114 may be adapted to securely store subscriber information and access to the sharing profiles block 114 may be controlled in a secure manner. Data associated with the sharing profiles block 114 may be encrypted, for example, in order to ensure that the data may not be compromised.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

FIG. 1b is a high level block diagram of an exemplary media exchange network having a media exchange server as illustrated in FIG. 1a in accordance with an embodiment of the invention. Referring to FIG. 1b, the media exchange network 140 may be a communication network which may include a personal computer 141 and a media processing system (MPS) 142 at a 1^{st} home 143 and a personal computer 144 and a media processing system 145 at a second (2^{nd}) home 146. The personal computer 141 and the media processing system 142 may interface to a broadband access headend 147, for example. The broadband access headend 147 may include a cable headend, a satellite headend, or a digital subscriber line (DSL) headend. The personal computer 141 and the media processing system 142 may include internal modems, for example a cable modem or DSL modem, or other interface devices, which may be adapted to communicate with the broadband access headend 147. Optionally, the interface device such as a modem may be external to the personal computer 141 and the media processing system 142.

Notwithstanding, the personal computer 144 and the media processing system 145 may interface to a broadband access headend 148. The broadband access headend 147 may be part of the same system, for example the same service provider, as broadband access headend 148. However, the invention is not limited in this regard and the broadband access headend 147 may be part of the same system as the broadband access headend 148. The broadband access headend 148 may comprise a cable headend, a satellite headend, or a DSL headend, for example. The personal computer 144 and the media processing system 145 may include one or more internal modems such as a plain of telephone service (POTS) modem, integrated services digital network (ISDN) modem, cable modem or DSL modem or other interface device capable of communicating with the broadband access headend 148. Optionally, the interface device, for example, a modem may be external to the personal computer 144 and the media processing systems 145.

The media exchange network 140 may further include a third (3^{rd}) party media provider 149 and a media exchange server 150. The media exchange server 150 may be provided in instances where there is a single central server supporting the media exchange network 140. Notwithstanding, the broadband access headend 147, the broadband access headend 148, the third (3^{rd}) party media provider 149, and the media exchange server 150 all connect to the Internet infrastructure 151. In one aspect of the present invention, a plurality of media exchange servers may be strategically located at various points in the media exchange network 140.

The media exchange network 140 may also include a media storage server 152, which may be adapted to interface with the Internet infrastructure 151. The media storage server 152 may be configured to interact with the media exchange server 150 and may provide temporary and/or archival storage for digital media on the media exchange network 140. For example, the media storage server 152 may temporarily hold media files that are addressed to certain media processing systems and/or personal computers coupled to the media exchange network 140.

The media exchange server 150 may also provide various services for the media exchange network 140 including device Internet protocol (IP) address registration, device ID registration, channel/program setup and management, serving as a proxy for anonymity, digital rights management, media caching/storage, and billing/tracking. The third (3^{rd}) party media provider 149 may comprise any of a number of providers of digital media including an on-demand movie provider, an advertiser, and an on-demand music provider.

In accordance with an embodiment of the present invention, a broadband access headend may be adapted to operate as a media exchange headend by adding functionality to facilitate the exchange of media on the media exchange network 140 in conjunction with the media exchange server 150. Such functionality may include, but is not limited to, distributed networking capability, archival functionality such as long term media storage, temporary storage which may aid in the distribution and routing of media for example, storage management, and digital rights management (DRM). The media exchange network 140 in conjunction with the media exchange server 150, may be utilized to solve problems associated with authorizing and establishing secure media exchange links between devices such as media processing systems 115, 119, 148 and personal computers 117, 122, 127 on the media exchange network 140.

The various elements of the media exchange network 140 may include storage locations for digital media and data. The storage locations may include, for example, hard disk drives, a digital versatile disc (DVD) player, a compact disc (CD) player, floppy disk drives, RAM, removable drives such as micro drives, any combination of these. The storage locations may also include, for example, memory cards, PCMCIA cards, smart-media, multi-media cards, compact flash cards, secure digital (SD) cards or any combination thereof. The personal computers 141, 144 may include, for example, desktop personal computers, notebook personal computers, PDA's, handhelds or any computing device.

The media processing systems 142, 145 may be essentially enhanced set-top-boxes. The media processing systems 142 and 145 may each include a television screen for viewing and interacting with various user interfaces, media, data, and services that may be available on the media exchange network using, for example, a remote control. The personal computers 141 and 144 may each include a personal computer monitor or other display or monitor for viewing and interacting with various user interfaces, media, data, and services that may be available on the media exchange network using, for example, a keyboard and mouse. The media processing systems 142, 145 and personal computers 141, 144 may include functional software to support interaction with the media exchange server 150 on the media exchange network 140, in accordance with various embodiments of the present invention. Other embodiments of the present invention may comprise various combinations and/or multiple instantiations of the elements of FIG. 1a, in accordance with various aspects of the present invention, including media peripheral devices such as, for example, digital cameras, digital camcorders and MP3 players.

Referring to FIG. 1a, the first location 105 may include a media processing system 115 and an access device such as a personal computer 117. The access device such as the personal computer 117 may include a storage block 118. The media processing system 115 may include a storage block 116. The second location 106 may include a media processing system 119, an access device such as a personal computer 122 and a media network access storage (121) unit. The access device such as the personal computer 122 may also include, for example, a storage block 123. The media processing system 119 may include a storage block 120. The media processing systems 115 and storage 116 may be adapted to operate similar to the media processing systems 145, 142 of FIG. 1b. personal computer 117 may also operate similar to personal computers 141, 144 of FIG. 1b.

The media network access storage (NAS) 121 may be a networked storage device that may be dedicated to storing data and may be configured to be accessed remotely or locally. In this regard, the media network access storage 121 may be a personal computer or a server in which the overhead processing and application have be thinned to facilitate storage services and functions. The media network access storage 121 may be coupled to the MPS via a link such as a wired and/or wireless communication link. The media network access storage 121 may include one or more of a plurality of buses such as SCSI, PCI, PCI-X or ISA, which may be adapted to interface with a plurality of compatible storage devices.

Finally, the third location 107 may include a media processing system 124, an access device such as a PC 127 and a media storage area network (SAN) 126. The access device such as the PC 127 may also include a storage block 128. The media processing system 124 may include, for example, a storage block 125. The media storage area network 126 may be similar to the media network attached storage 121, but media storage area network 126 may be adapted to physically separate data storage functions from data processing functions. In this regard, the media storage area network 126 may include a high bandwidth transfer medium that may be adapted to transfer information to and from a plurality of high density storage devices, for example. In one aspect of the invention, the media storage area network 126 may be utilized only for high volume storage. One difference that may exist between the media storage area network 126 and the media network access storage 121 is the media storage area network 126 may not have any operating system (OS) or in a case where the media storage area network 126 may have operating system support, OS support may be significantly less that that possessed by the media network access storage 121.

The media SAN 126 and the media NAS 121 may provide separation of data processing and data storage functions. This may ensure additional security and increase data integrity. One or more of the media SAN 126 and the media NAS 121 may be adapted to interface with and transfer information for one or more of a plurality of networks. For example, the media SAN 126 and/or the media NAS 121 may be coupled to a plurality of Ethernet networks and fibre channel networks.

FIG. 1c is a block diagram of the exemplary media processing system of FIG. 1a in accordance with an embodiment of the invention. Referring to FIG. 1c, the media processing system 152 may include a networking block 153, a media processing block 154, a local storage block 155, a remote controller block 156, a video display block 157 and an audio display block 158. The media network storage 152 may be coupled to a data feed such as a plurality of broadcast channels via a wired, wireless or hybrid wired/wireless means.

The networking block 153 may include suitable network interfaces, hardware and/or software that may be adapted to provide communication with the media NAS 121 and/or the media SAN 126.

The media processing block 154 may be adapted to include any one or more of and encoder, a decoder, a transcoder, an encrypter, a decrypter and/or other hardware that may be adapted to process data. The processed data may converted from a first data format to a second suitable format that may be represented by one or more of the video display block 157 and/or the audio display block 158. The media processing block 154 may be adapted to process, for example, Dolby or THX formatted output for display on one or more of the video display block 157 and/or the audio display block 158. Data may be converted from proprietary or non-standard formats to standardized formats such as MPEG2 or MPEG 4.

The local storage block 155 may include suitable memory that may be utilized for storing long term data or short term data. With regard to short term data, the local storage block may include suitable RAM or cache memory that may be adapted to process audio and/or visual data. The local storage may be a hard disk or may even include a system containing a mass storage device such as a personal video recorder (PVR).

The video display block 157 may include one or more of a plurality of monitors or TV screens that may be adapted to provide a visual representation of the data processed by the media processing system 152. The audio display block 158 may include one or more of a plurality of audio devices such as speakers and/or microphones that may be adapted to provide an aural representation of the data to be processed or data processed by the media processing system 152. The video display block 157 and/or the audio display block 158 may be wired or wirelessly coupled to the media processing system 152. In a case where the video display block 157 and/or the audio display block 158 may be wirelessly coupled to the media processing system 152, the video display block 157 and/or the audio display block 158 may utilize Bluetooth or spread spectrum at 900 MHz, 2.4 GHz or 48 GHz, for example.

FIG. 1d is a block diagram of the exemplary media network storage device of FIG. 1a in accordance with an embodiment of the invention. The media network storage device 159 of FIG. 1d may include a storage management block 160, a coder/transcoder block 161, a CD juke box 162, an audio tape player 163, a redundant array of inexpensive discs (RAID) block 164, a miscellaneous device block 165, a memory card adapted 166, a DVD juke box 167, and a interface 168. These devices may include suitable circuitry that may permit hot swapping.

The storage management block 160 may include suitable interfaces, hardware and/or software that may be adapted to manage the processing and transfer of information to and from the media network storage device 121. In this regard, the storage management block 160 may include, for example, a suitable Ethernet network card and networking software for communication. The storage management block 160 may also include a thin OS. In one aspect of the invention, the media NAS 159 may not include support for a keyboard, a video display and/or an audio display. However, the invention is not limited in this regard and the media NAS 159 may include support for a keyboard, a video display and/or an audio display.

The media NAS 159 may also include a coder and/or a transcoder block 161. A transcoder function within the transcoder block 161 may be adapted to transcode data from a first format to a second format so that it may be interpreted by a first device. Similarly, in the reverse direction, the transcoder function may be adapted to transcode data from a second format to a first format so that it may be interpreted by a second device. An encoder function within the coder block 161 may be adapted to encode data in a specified format for transmission. A decoder function within the coder block 161 may also be adapted to decode data that has been previously encoded in a specified format. In general, the coder/transcoder block 161 may be adapted to handle the formatting and transformation of data formats to ensure that data may be represented in an appropriate format.

The redundant array of inexpensive discs (RAID) block 164 may be utilized to provide redundant storage of data. The RAID block 164 may one or more high speed interfaces such as SCSI, serial-attached SCSI and fibre channel that may be adapted to provide connectivity to one or more storage devices.

The audio tape player 163, CD juke box 162, DVD jukebox 167 may be similar to those devices which are presently utilized for displaying audio and/or video content such as songs and movies.

The memory card adapter block 166 may be any suitable connector or array of connectors that may be adapted to provide a connecting interface for one or more of a plurality of media devices. The devices may include, but are not limited to, smart cards, smart media disks, micro drives and compact flash cards. The miscellaneous device block 165 may include various other devices that may be adapted to store and/or facilitate the storage and transfer of data.

The interface 168 may be a wired, wireless and/or hybrid wired/wireless interface that may be adapted to provide connectivity for a plurality of devices. One or more of a plurality of personal media peripherals 169 may be coupled to the media NAS 159 via the interface 168. Exemplary devices that may be coupled to the media NAS 159 via the interface 168 may include an MP3 player 169a, a network camera 169b and a PDA 169c.

FIG. 1e is a block diagram of the exemplary media storage area network of FIG. 1a in accordance with an embodiment of the invention. The exemplary media storage area network 170 may include a file system block 171, a storage server block 172 and at least one interface. As illustrated, there is shown a first interface 173 and a second interface 174. The first interface 173 is a device interface and the second interface 174 is a bus interface. In one aspect of the invention, there may be a plurality of bus interfaces and/or a plurality of device interfaces. The file system block 171 may include a current file system index 171a. Medium 186 may be adapted to couple the second interface 174 to a wireless network 175. Medium 186 may be a wired, wireless or hybrid wired/wireless medium. A plurality of personal media peripherals 176 may communicate with the wireless network 175.

The first interface 173 may be coupled to the channel 185 via the media 187. The channel 185 may be an Ethernet channel, a fiber channel, or other high speed, high density channel, for example. A RAID block 177 may be coupled to the channel 185. The RAID block 177 may be a software RIAD or a hardware RAID. Notwithstanding, RAID block 177 may include a plurality of storage devices 177a, 177b, which may be coupled to the channel 185.

A memory card adapter block 178, a tape device 179, an optical storage device block 180 and a network media peripheral block 181 may also be coupled to the channel 185. The network media peripheral block 181 may include a plurality of network media peripherals 181a, 181b, 181c. Exemplary network media peripherals may include a network camera, a PDA and an MP3 player. An audio tape player 184, a CD jukebox 183 and a DVD jukebox 182 may also be coupled to the channel 185. Any one or more of the audio tape player 184, a CD jukebox 183 and a DVD jukebox 182 may include an optional coder and/or transcoder block 184a, 183a and 182a, respectively.

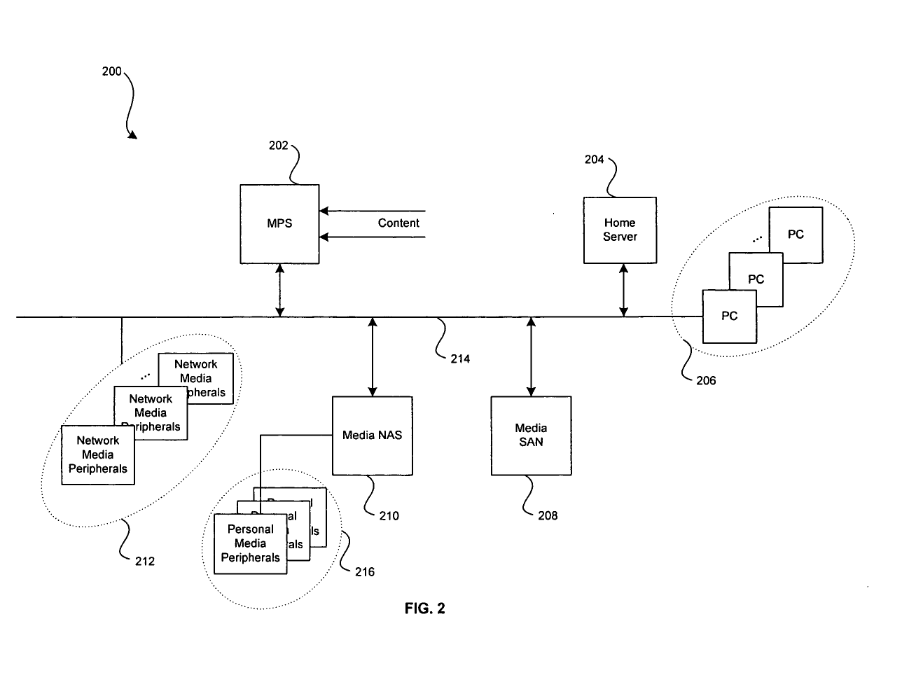

FIG. 2 is a block diagram of an exemplary media independent storage, access and distribution network in accordance with an embodiment of the invention. The media independent storage, access and distribution network 200. Referring to FIG. 2, there is shown a media processing server 202, a local server such as home server 204, a plurality of personal computers 206, a media SAN 208, a media NAS 210 and a network media peripherals block 212. Each of the processing server 202, the home server 204, the PCs 206, the media SAN 208, the media NAS 210 and the network media peripherals block 212 may be coupled to the network or channel 214. The network or channel 214 may be a wired, wireless or hybrid wired/wireless network or channel. A plurality of personal media peripherals may be coupled in a wired, wirelessly or a combination thereof to the to media NAS 210.

In operation, data stored in one or more of the personal media devices may migrate to a long term storage such as a tape backup or a RAID storage device. For example, data on a memory card may migrate from the memory card onto the tape backup for permanent storage. In one aspect of the invention, the migration of data from the personal media peripherals, for example, may be automatic or it may manually be done. In automatic mode, after the data resides on the personal media peripheral for a specified period, it may automatically be transferred to a more permanent storage. In another aspect of the invention, various aspects of data migration may further include caching copies of transferred. The data may be cached or mirrored once or it may be cached or mirrored a plurality of times.

The media SAN 208 and/or the media NAS 210 may be adapted to keep track of all location and transfer of data files within the system. In this regard, the current index block 171a of the file system block 171 of FIG. 1e may be adapted to track and store information pertaining to a current location of all files within the system. Although the file system block 171 and current index block 171a are illustrated in the media SAN 208, the invention is not so limited. In other embodiments of the invention, file system block 171 and current index block 171a may be located within the media NAS block 208 and or the MOS 202. A distributed file system and index may also be employed to track the transfer of data in the media independent storage, access and distribution network 200. Notwithstanding, when a request for data is received, the file system block 171 and the current index 171a may be utilized to locate a most recent and/or closest cached or mirrored data copy.

In another aspect of the invention, the file system block 171 and the file index block 171a may be adapted to control folders that may be adapted to store a plurality of files. The folder may contain files that match a specified criteria or the files may be randomly stored in the folder. Notwithstanding, the file system block 171 and the file index block 171a may be adapted to control which device or subscribers, for example, may be permitted access to the files and/or folders. For example, certain PCs may be blocked from accessing certain data. Similarly, certain personal media peripherals may be blocked from storing or writing information to, for example, the NAS 202 and/or the media SAN 208. This may be particularly useful in instances where there may be a threat of a virus, for example. In another aspect of the invention, in order to provide adequate safeguards and enhanced security, publicly accessible data may be placed in a public folder and private data may be place in a secure folder. The secure folder may be configured so that it may require a password. In this regard, a media SAN 208 or a media NAS 210 for a first location may be accessible by subscribers from other locations. Hence, with proper rights and/or permission, subscribers from other locations may utilize the media SAN 208 or media NAS 210 at the first location.

In another aspect of the invention, the file system block 171 and the file index block 171a may control the transfer of information from the CD juke box 162, audio tape player, 163, RAID block 164, memory stock adapter 166, and DVD juke box 167, for example. By applying one or more rules which may define access rights, file system block 171 and the file index block 171a in conjunction with the home server 204 may permit a subscriber or device having proper access rights to access content from any one or more of the devices coupled to the NAS 210. These devices may include, but are not limited to, CD juke box 162, audio tape player, 163, RAID block 164, memory stock adapter 166, and DVD juke box 167. Similarly, file system block 171 and the file index block 171a in conjunction with the home server 204 may permit a subscriber or device having proper access rights to access content from any one or more of the devices coupled to the media SAM 208.

U.S. Provisional Application Serial No. 60/444,243 (Attorney Docket No. 14282US01) filed Jan. 30, 2003, describes the migration of stored media through a media exchange network and is incorporated herein by reference in its entirety.

Certain aspects of the method for providing media in a communication network may comprise receiving a media file at a first home via the communication network. The media file may be received from outside the first home such as location 105 and a first format for the received media file may be determined within the first home 105. Accordingly, the received media file may be converted from the first format to a second format that is compatible with presenting and/or playing the converted media file on a television screen within the first home 105. The received media file may be audio, video, images, graphical and/or textual media. For example, the first and/or second format may include, but is not limited to, text files (txt) such as TXT and RTF; image files such as GIF and JPG; audio files such as AIFF, MIDI, AU, WAV, MP3 and video files such as AVI, ASF, WMV, ASF, WMA, MP3, MPEG, MPEG-x, and MOV.

The received media file may be decoded and/or decrypted within the first home 105. Also, the received media file may be transcoded from the first format to the second format. The converted media file may be directly transferred to one or more media peripherals that may be located within the first home 105. The converted media file may also be distributed or migrated to a media peripheral within the first home 105 and/or a media peripheral within a second home such as location 107 via a wired and/or wireless connection. In this regard, authorization may be received prior to distributing or migrating the converted media file to a media peripheral that is located at the second home 107 or outside the second home 107.

In another aspect of the invention, the converted media file may be stored in a network attached storage and/or a storage area network located within a first home 105 and/or a second home 107. The stored converted media file may be retrieved and displayed on the television screen that is located within the first home. The received media file may also be stored in at least one of a network attached storage, a storage server and a storage area network prior to being converted from the first format to the second format.

Another embodiment of the invention may provide a system for providing media in a communication network. The system may comprise at least one processor that may be adapted to receive a media file at a first home via the communication network. The media file may be received from outside the first home and the processor may determine a first format of the received media file within the first home. Accordingly, the processor may convert the received media file from the first format to a second format. The second format may be compatible with presenting and/or playing the converted media file on a television screen within the first home. The received media file may be audio, video, image, graphical and/or textual media. The processor may be a media processing system processor, a media management system processor, a computer processor, a media exchange software processor and/or a media peripheral processor.

Notwithstanding, the processor may decode or decrypt the received media file within the first home 105. The processor may also be adapted to transcode the received media file from the first format to the second format that is compatible for presentation on the television screen within the first home 105. The converted media file may be transferred by the processor to one or more media peripherals that are located within the first home 105. The processor may also be configured to distribute the converted media file to a media peripheral within the first home 105 and/or a media peripheral within a second home 107 via a wired and/or wireless connection. In this regard, the processor may be adapted to receive authorization prior to distributing or otherwise migrating the converted media file to a media peripheral that is located at the second home 107 or outside of the first home 105.

In another aspect of the invention, the converted media file may be stored by the processor in a network attached storage and/or a storage area network located within a first home 105 and/or a second home 107. In cases where the converted media file is stored, the stored converted media file may be retrieved by the processor and displayed on the television screen that is located within the first home. The received media may also be stored by the processor in a network attached storage 121, a storage server and/or a storage area network 126 prior to being converted from its first format to the second format.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

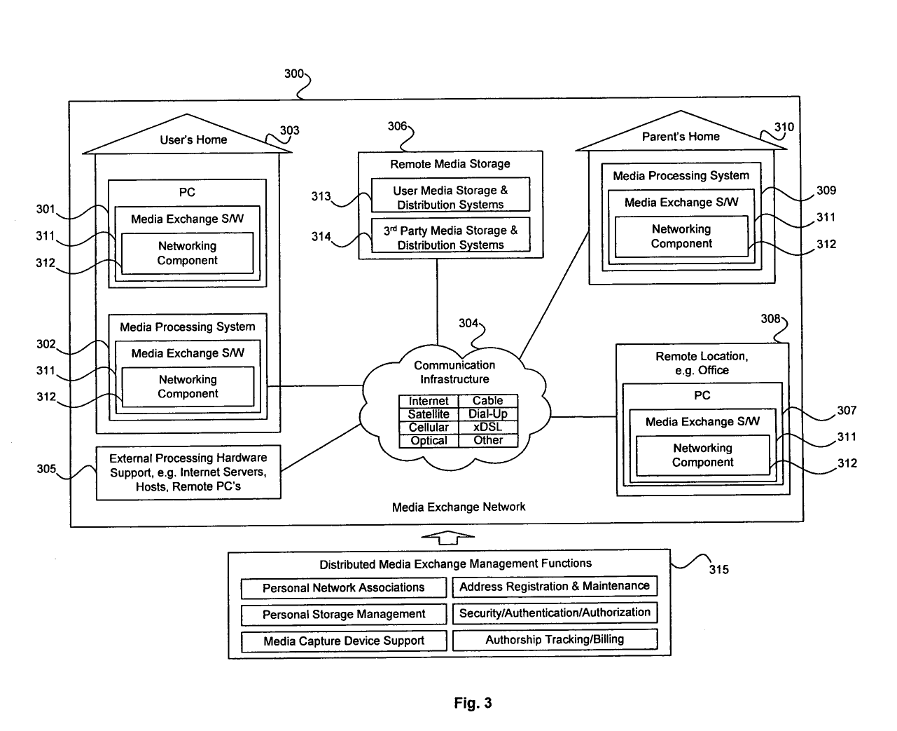

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

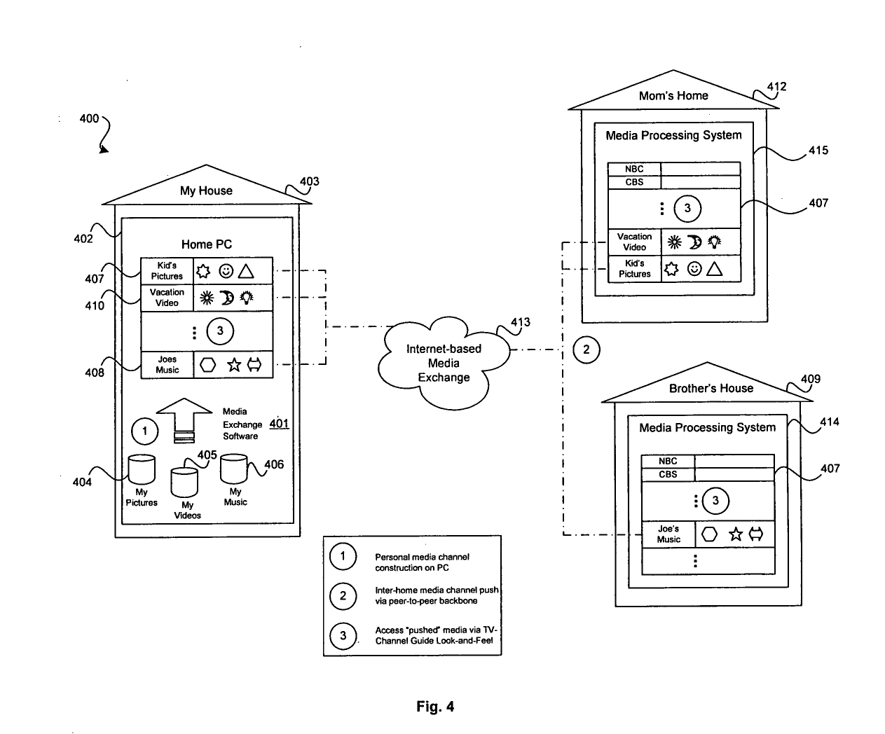

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

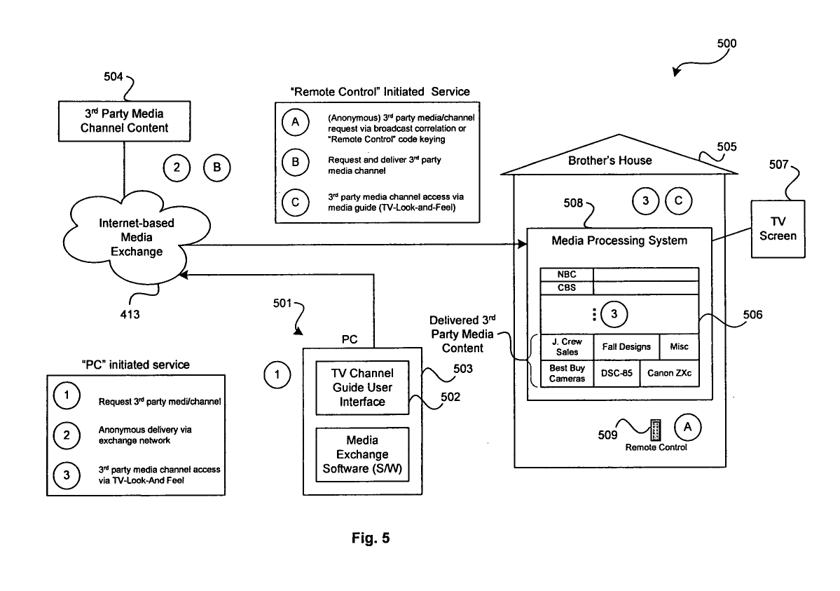

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

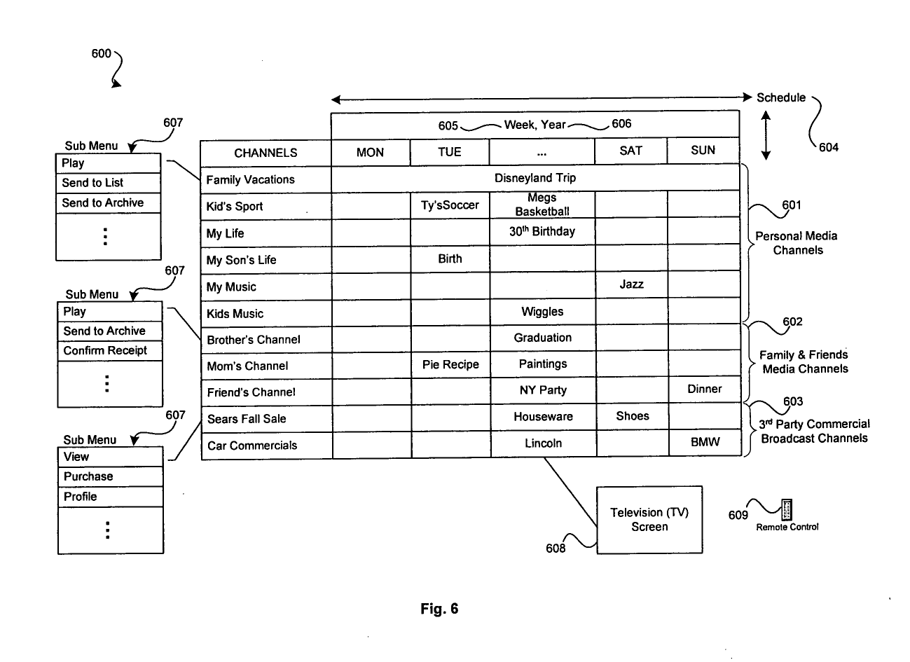

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

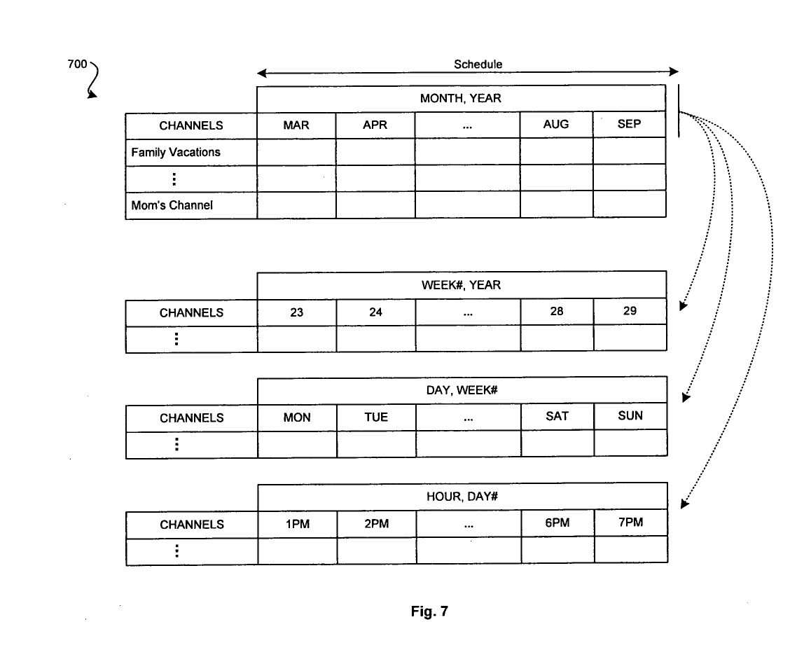

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

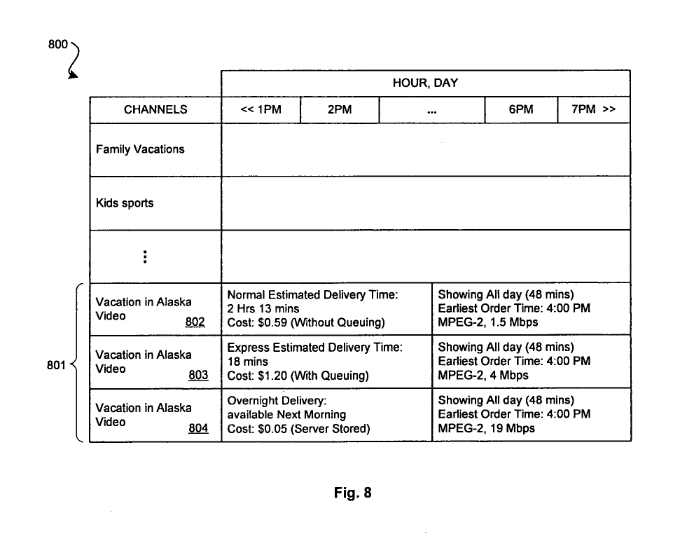

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

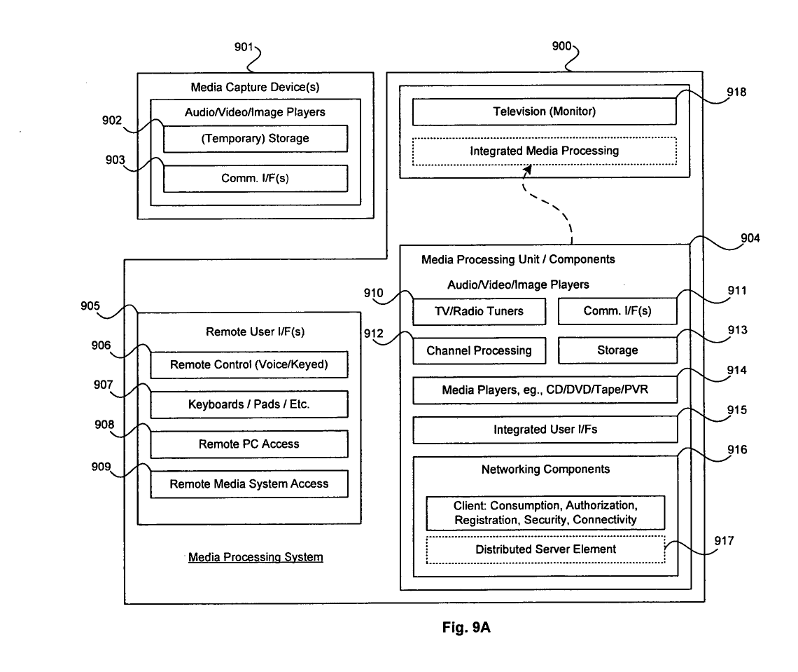

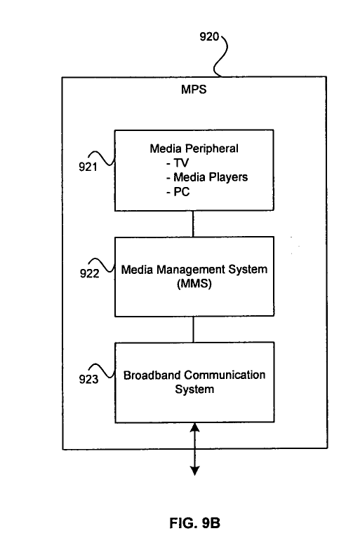

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

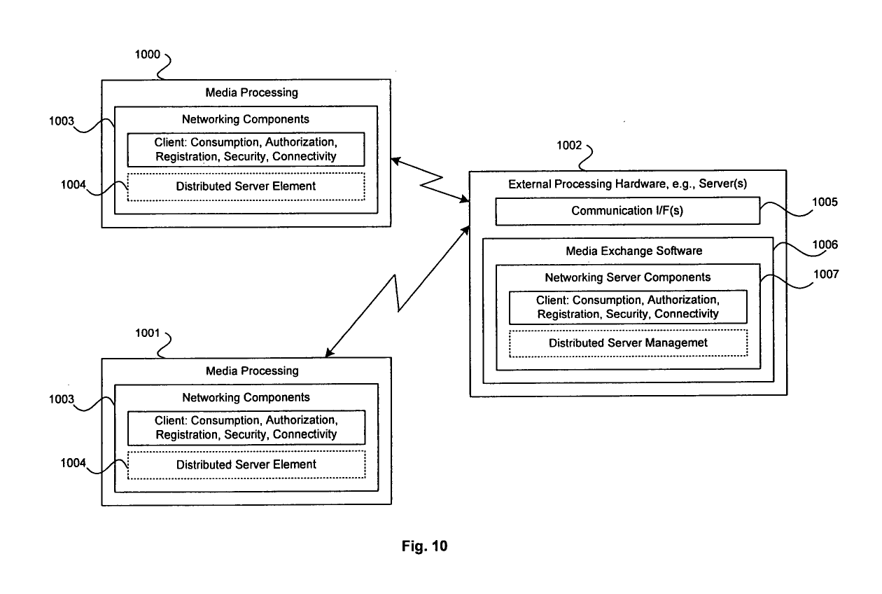

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

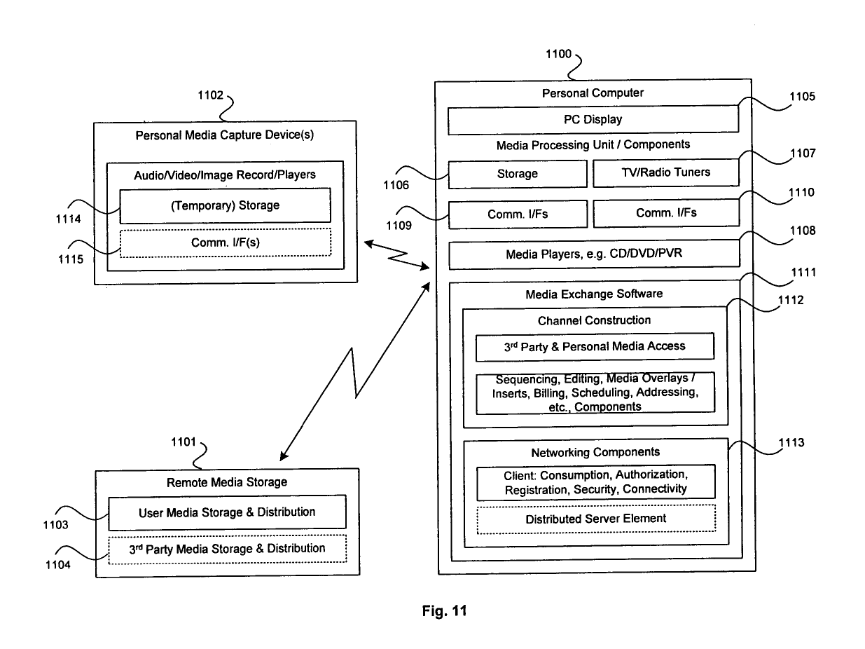

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Certain embodiments of the invention may comprise a method and system for providing media independent storage, access and distribution of data in a media exchange network. Certain embodiments of the present invention relate to various migration rules for storage, programming, and scheduling of media, data, and services. In an embodiment of the invention, media may be received from outside a first home at a first home via the communication network. A format for the received media may be determined within the first home. The received media may be converted from its determined format to a format compatible for presenting and/or playing the converted media on a television screen within the first home. The converted format compatible for presenting and/or playing the converted media may be a format other than a broadcast television format.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing media in a communication network, the method comprising:
receiving a media file from the communication network at a first home, said media file received from outside said first home;
determining within said first home, a first format of said received media file; and
converting within said first home, said received media file from said first format to a second format compatible for at least one of presentation and playback on a television screen within said first home.

2. The method according to claim 1, further comprising at least one of decoding and decrypting said received media file within said first home.

3. The method according to claim 1, further comprising transcoding said received media file within said first home from said first format to said second format.

4. The method according to claim 1, further comprising directly transferring said converted media file to at least one media peripheral located within said first home.

5. The method according to claim 1, further comprising distributing said converted media file to at least one of a media peripheral within said first home and a media peripheral within a second home via at least one of a wired and a wireless connection.

6. The method according to claim 5, further comprising receiving authorization for said distributing of said converted media file to said at least one media peripheral within said second home.

7. The method according to claim 1, further comprising storing said converted media file in at least one of a network attached storage and a storage area network within at least one of said first home and a second home.

8. The method according to claim 7, further comprising:
retrieving said stored converted media file; and
displaying on said television screen within said first home, said retrieved converted media file.

9. The method according to claim 1, further comprising storing said received media file prior to said converting in at least one of a network attached storage, a storage server and a storage area network located at said first home.

10. The method according to claim 1, wherein said received media file is at least one of audio, video, image, graphical and textual media file.

11. A machine-readable storage having stored thereon, a computer program having at least one code section for providing media in a communication network, the at least one code section being executable by a machine for causing the machine to perform steps as described above in the method.
receiving a media file from the communication network at a first home, said media file received from outside said first home;
determining within said first home, a first format of said received media file; and
converting within said first home, said received media file from said first format to a second format compatible for at least one of presentation and playback on a television screen within said first home.

12. The machine-readable storage according to claim 11, further comprising at least one of code for decoding and code for decrypting said received media file within said first home.

13. The machine-readable storage according to claim 11, further comprising code for transcoding said received media file within said first home from said first format to said second format.

14. The machine-readable storage according to claim 11, further comprising code for directly transferring said converted media file to at least one media peripheral located within said first home.

15. The machine-readable storage according to claim 11, further comprising code for distributing said converted media file to at least one of a media peripheral within said first home and a media peripheral within a second home via at least one of a wired and a wireless connection.

16. The machine-readable storage according to claim 15, further comprising code for receiving authorization for said distributing of said converted media file to said at least one media peripheral within said second home.

17. The machine-readable storage according to claim 11, further comprising code for causing said converted media file to be stored in at least one of a network attached storage and a storage area network within at least one of said first home and a second home.

18. The machine-readable storage according to claim 17, further comprising:
code for retrieving said stored converted media file; and
code for displaying on said television screen within said first home, said retrieved converted media file.

19. The machine-readable storage according to claim 11, further comprising code for storing said received media file prior to said converting in at least one of a network attached storage, a storage server and a storage area network located at said first home.

20. The machine-readable storage according to claim 11, wherein said received media file is at least one of audio, video, image, graphical and textual media file.

21. A system for providing media in a communication network, the system comprising:
at least one processor that receives a media file from the communication network at a first home, said media file received from outside said first home;
said processor determines within said first home, a first format of said received media file; and
said processor converts within said first home, said received media file from said first format to a second format compatible for at least one of presentation and playback on a television screen within said first home.

22. The system according to claim 21, wherein said at least one processor at least one of decodes and decrypts said received media file within said first home.

23. The system according to claim 21, wherein said at least one processor transcodes said received media file within said first home from said first format to said second format.

24. The system according to claim 21, wherein said at least one processor directly transfers said converted media file to at least one media peripheral located within said first home.

25. The system according to claim 21, wherein said at least one processor distributes said converted media file to at least one of a media peripheral within said first home and a media peripheral within a second home via at least one of a wired and a wireless connection.

26. The system according to claim 25, wherein said at least one processor receives authorization for said distributing of said converted media file to said at least one media peripheral within said second home.

27. The system according to claim 21, wherein said at least one processor stores said converted media file in at least one of a network attached storage and a storage area network within at least one of said first home and a second home.

28. The system according to claim 27, wherein said at least one processor:
retrieves said stored converted media file; and
causes said retrieved converted media file to be displayed on said television screen within said first home.

29. The system according to claim 21, wherein said at least one processor stores said received media file prior to said converting in at least one of a network attached storage, a storage server and a storage area network located at said first home.

30. The system according to claim 21, wherein said received media file is at least one of audio, video, image, graphical and textual media file.

31. The system according to claim 21, wherein said at least one processor is at least one of a media processing system processor, a media management system processor, a computer processor, a media exchange software processor and a media peripheral processor.
